(19) United States
(12) Patent Application Publication
(10) Pub. No.: US 2026/0029354 A1
(43) Pub. Date: Jan. 29, 2026

(54) COMPENSATING FOR DEFORMATION OF A SAMPLE DURING MEASUREMENT

(71) Applicant: Onto Innovation Inc., Wilmington, MA (US)

(72) Inventor: Holly Edmundson, Hillsboro, OR (US)

(73) Assignee: Onto Innovation Inc., Wilmington, MA (US)

(21) Appl. No.: 18/784,716

(22) Filed: Jul. 25, 2024

(51) Int. Cl. G01N 21/95; G01B 11/06

(52) U.S. Cl. CPC G01N 21/9501; G01B 11/0608; G01N 2201/021

(57) ABSTRACT

Non-contact measurement of a sample is performed by compensating for local deformation of the sample. A map of localized deformations of the sample is obtained. The localized deformations, for example, may be produced by sample deformation, such as bow and warp, chuck imprinting on the sample, or both. A location on the sample is measured while the sample is mounted to the chuck. A localized deformation at the location on the sample produces an alteration of an angle of incidence, an azimuth angle, or both, for the radiation used for measuring the location. The alteration of the angle of incidence, the azimuth angle, or both, at the location is corrected based on the map of localized deformations.

### FIELD OF THE DISCLOSURE

The subject matter described herein is related generally to metrology, and more particularly to compensating for induced deformations on a sample during measurement.

### BACKGROUND

Semiconductor and other similar industries often use metrology equipment, such as optical metrology equipment, to provide non-contact evaluation of samples during processing. With optical metrology, a sample under test is illuminated with light, e.g., at a single wavelength or multiple wavelengths. After interacting with the sample, the resulting light is detected and analyzed to determine one or more characteristics of the sample.

Non-contact metrology systems provide accurate and high-precision measurement of samples based on the interaction of light (or other type of radiation used) with the sample. Proper alignment and calibration of such systems is typically required to achieve the desired measurements because the metrology systems are highly sensitive to measurement parameters. Samples undergoing measurement, however, may suffer from significant deformation, e.g., due to tensile stress during processing, temperature variations, material impurities, etc. Samples may be clamped to a flat chuck during measurement, e.g., using vacuum or electrostatic force, but samples may still suffer from localized deformations, particularly in overhanging portions. Moreover, surface features from the chuck may be imprinted on the surface of the chuck. The localized deformation of the sample may alter parameters of the metrology system, such as angle of incidence and azimuth angle. Due to the sensitivity of the metrology systems, localized deformations in measurement locations may result in inaccurate and unreliable measurements.

### SUMMARY

Non-contact measurement of a sample is performed while compensating for local deformation of the sample. The localized deformations, for example, may be produced by sample deformation, such as bow and warp, chuck imprinting on the sample, or both. To compensate for a localized deformation during measurement, a map of localized deformations of the sample is obtained. The map of localized deformations may be produced offline and obtained from memory or may be generated, e.g., based on measurements of the sample deformation, surface features of the chuck or both. The map of localized deformations, for example, obtained based on one or more measurements, e.g., of sample deformation, surface features of the chuck or both. The map of localized deformations may be stored in memory and obtained from memory during measurement of the sample. The sample is mounted to the chuck and the sample is measured at a location. A localized deformation at the location on the sample produces an alteration of an angle of incidence, an azimuth angle, or both, for the radiation used for measuring the location. The map of localized deformations is used to correct the alteration of the angle of incidence, the azimuth angle, or both. The correction, for example, may be performed by adjusting the relative orientation of the sample to the metrology device or by parameterizing the angle of incidence, an azimuth angle, or both based on the map of localized deformations while determining one or characteristics of the sample based on the measurement from the location.

In one implementation, a method of compensating for deformation of a sample during measurement includes obtaining a map of localized deformations of the sample produced by at least one of sample deformation and chuck imprinting on the sample when the sample is mounted to a chuck. A location on the sample is measured with the sample mounted to the chuck. A localized deformation at the location of the sample when the sample is mounted to the chuck produces an alteration of at least one of an angle of incidence and an azimuth angle of radiation used for measuring the location. The angle of incidence is with respect to a normal vector at the location and the azimuth angle is with respect to a pattern at the location. The alteration of the at least one of angle of incidence and the azimuth angle of the radiation caused by the localized deformation at the location is corrected based on the map of localized deformations.

In one implementation, a metrology device configured for compensating for deformation of a sample during measurement includes a stage and chuck configured to hold a sample and at least one metrology head configured for measuring a location on the sample with the sample mounted to the chuck. The metrology device includes at least one processor that is coupled to the stage and chuck and the at least one metrology head and is configured to perform various operations. The at least one processor is configured to obtain a map of localized deformations of the sample produced by at least one of sample deformation and chuck imprinting on the sample when the sample is mounted to a chuck. The at least one processor is further configured to measure the location on the sample with the sample mounted to the chuck. A localized deformation at the location of the sample when the sample is mounted to the chuck produces an alteration of at least one of an angle of incidence and an azimuth angle of radiation used for measuring the location. The angle of incidence is with respect to a normal vector at the location and the azimuth angle is with respect to a pattern at the location. The at least one processor is further configured to correct for the alteration of the at least one of angle of incidence and the azimuth angle of the radiation caused by the localized deformation at the location based on the map of localized deformations.

In one implementation, a metrology device configured for compensating for deformation of a sample during measurement includes means for obtaining a map of localized deformations of the sample produced by at least one of sample deformation and chuck imprinting on the sample when the sample is mounted to a chuck. The metrology device further includes a means for measuring a location on the sample with the sample mounted to the chuck. A localized deformation at the location of the sample when the sample is mounted to the chuck produces an alteration of at least one of an angle of incidence and an azimuth angle of radiation used for measuring the location. The angle of incidence is with respect to a normal vector at the location and the azimuth angle is with respect to a pattern at the location. The metrology device further includes means for correcting for the alteration of the at least one of angle of incidence and the azimuth angle of the radiation caused by the localized deformation at the location based on the map of localized deformations.

### BRIEF DESCRIPTION OF THE DRAWINGS

FIG. 1 illustrates a schematic view of a non-contact metrology device that may be configured to compensate for deformation of a sample during metrology, as described herein.

FIGS. 2A and 2B illustrate side views of a chuck and an unclamped and clamped sample, respectively, to illustrate localized deformation due to dome shaped sample deformation.

FIGS. 3A and 3B illustrate side views of a chuck and an unclamped and clamped sample, respectively, to illustrate localized deformation due to bowl shaped sample deformation.

FIG. 4 illustrates a side view of a chuck and clamped sample to illustrate localized deformation due to an object on the surface of the chuck.

FIGS. 5A and 5B illustrate perspective views of a chuck and an unclamped and clamped sample, respectively, to illustrate localized deformation of the sample due to chuck imprinting of surface features of the chuck.

FIGS. 6A and 6B illustrate a side view of a sample and the effect of a localized deformation on the angle of incidence of light during measurement.

FIGS. 6C and 6D illustrate a top view of the sample and the effect of a localized deformation on the azimuth angle of the light during measurement.

FIGS. 6E and 6F illustrate a side view of a portion of a sample and the effect of a localized deformation on normal incidence illumination.

FIG. 7 illustrates an example of a map of localized deformations of a sample resulting from chuck imprinting on a sample.

FIG. 8A illustrates a side view of a chuck and an unclamped sample and illustrates generating a map of localized deformations of the sample.

FIG. 8B illustrates a side view of a chuck and a clamped sample and illustrates generating a map of localized deformations of the sample.

FIGS. 8C and 8D illustrate side views of the chuck and the sample during measurement at a location and illustrate different implementations of compensating for alterations of the angle of incidence, azimuth angle, or both at the location based on the map of localized deformations of the sample.

FIG. 9A illustrates a side view of a chuck and illustrates generating a map of localized deformations of a sample.

FIG. 9B illustrates a side view of a chuck and a clamped reference sample and illustrates generating a map of localized deformations of a sample.

FIGS. 9C and 9D illustrate side views of the chuck and the sample during measurement at a location and illustrate different implementations of compensating for alterations of the angle of incidence, azimuth angle, or both at the location based on the map of localized deformations of the sample.

FIG. 10 illustrates a flowchart depicting an example method for compensating for deformation of a sample during metrology of the sample, according to some implementations.

### DETAILED DESCRIPTION

During fabrication of semiconductor devices and similar devices it is often necessary to monitor the fabrication process by non-destructively measuring the devices. Optical metrology and X-ray metrology are examples of non-contact metrology techniques that may be employed for non-contact evaluation of samples during processing. Metrology systems are typically highly sensitive device parameters, such as angle of incidence and azimuth angle. Localized deformation of samples, e.g., caused by sample deformation and/or chuck imprinting, however, may alter parameters, such as angle of incidence and azimuth angle at certain locations on the sample, may produce inaccurate and unreliable measurements, and is conventionally excluded from measurement.

As discussed herein, localized deformations of a sample during measurement of the sample are corrected based on a map of localized deformations of the sample. The map of localized deformations may be a map of the entire sample or may be for one or more regions, but less than the entire sample. In some implementations, the map of localized deformations may be generated based on measured sample deformation, such as bow and warp, from which localized deformations of the sample, may be predicted. In some implementations, the map of localized deformations may be generated based on measured surface features of the chuck, from which the localized deformations on the sample may be predicted. The map of localized deformations may be used to compensate for alterations to the angle of incidence and azimuth angle produced during measurement at a measurement location. For example, the map of localized deformations may be used to determine the expected alteration to the angle of incidence and azimuth angle at the measurement location, from which the alteration to the angle of incidence and azimuth angle produced during measurement may be corrected. In some implementations, the relative orientation between the sample and the metrology head may be adjusted to compensate for the expected alteration to the angle of incidence and azimuth angle at the measurement location. In some implementations, the expected angle of incidence and azimuth angle at the measurement location may be parameterized and used to along with the measured data from the measurement location to determine one or characteristics of the sample.

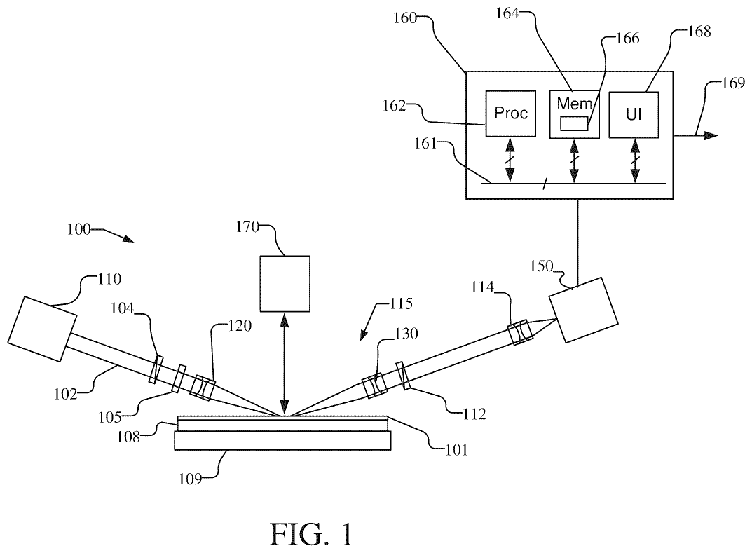

FIG. 1, by way of example, illustrates a schematic view of a non-contact metrology device 100 that may be configured to compensate for deformation of a sample during metrology, as described herein. The metrology device 100 is illustrated as an optical metrology device, but it should be understood that other types of non-contact metrology devices, including X-ray metrology devices may be used. As illustrated, the metrology device 100 may be configured to perform, e.g., spectroscopic reflectometry, spectroscopic ellipsometry (including Mueller matrix ellipsometry), spectroscopic scatterometry, overlay scatterometry, interferometry, or FTIR measurements, of a sample 101 that includes one or more structures to be measured. It should be understood that metrology device 100 is illustrated as one example of a configuration for a metrology device that may be used with deformation compensation discussed herein, and that if desired other metrology device configurations may be used, including normal incidence devices, non-polarizing devices, etc. or other types of non-contact metrology devices may be used, including devices that use other types of radiation or measurement schemes, such as X-ray metrology devices, opto-acoustic devices, etc.

The sample 101 may be mounted to a chuck 108 that is connected to a stage 109. The sample 101 may be mounted to the chuck 108 in various ways, including gravity or clamping. For example, the sample 101 may be held to the surface of the chuck 108 (or lift pins on the chuck 108) simply be gravity or may be clamped to the surface of the chuck, e.g., by vacuum or electrostatic force, or may be clamped at three or more points along the perimeter of the sample 101. Thus, the chuck 108, for example, may be a vacuum chuck, a gravity chuck, an electrostatic chuck, and edge clamping chuck, or any other type of chuck, that is configured to hold the sample 101 during measurement.

The stage 109 and an optical head 115, e.g., including optics 120, 130, of the metrology device 100, are configured to produce relative positioning and orientation between the sample 101 and the optical head 115. For example, stage 109 may include actuators configured to position and orient the sample 101 relative to the optical head 115, or the optical head 115 may include actuators configured to position and orient the optical head 115 relative to the sample 101, or both the stage 109 and optical head 115 may include actuators configured to produce the relative position and orientation of the sample 101 relative to the optical head 115. By way of example, one or both of the stage 109 and optical head 115 may include actuators configured for horizontal motion in either Cartesian (i.e., X and Y) coordinates, or Polar (i.e., R and θ) coordinates or some combination thereof. One or both of the stage 109 and optical head 115 may further include one or more actuators configured for vertical motion along the Z coordinate. One or both of the stage 109 and optical head 115 may further include one or more actuators configured to control the orientation of the sample 101 with respect to the optical head, e.g., to adjust tilt.

Metrology device 100 includes a light source 110 that produces light 102. The light 102, for example, UV-visible light with wavelengths, e.g., between 200 nm and 1000 nm. The light 102 produced by light source 110 may include a range of wavelengths, i.e., continuous range or a plurality of discrete wavelengths, or may be a single wavelength. The metrology device 100 includes focusing optics 120 and 130 that focus and receive the light and direct the light to be obliquely incident on a top surface of the sample 101. The optics 120, 130 may be refractive, reflective, or a combination thereof and may be an objective lens.

The reflected light may be focused by lens 114 and received by a detector 150. The detector 150 may be a conventional charge coupled device (CCD), photodiode array, CMOS, or similar type of detector. The detector 150 may be, e.g., a spectrometer if broadband light is used, and detector 150 may generate a spectral signal as a function of wavelength. A spectrometer may be used to disperse the full spectrum of the received light into spectral components across an array of detector pixels. One or more polarizing elements may be in the beam path of the metrology device 100. For example, metrology device 100 may include one or both (or none) of one or more polarizing elements 104 in the beam path before the sample 101, and a polarizing element (analyzer) 112 in the beam path after the sample 101, and may include one or more additional optical elements 105, such as a waveplate, compensator, photoelastic modulator etc., which may be before, after, or both before and after the sample 101.

In some implementations, metrology device 100 may include a separate metrology instrument 170, e.g., for measuring the topography of the sample 101 (and in some implementations the topography of chuck 108). Metrology instrument 170, for example, may perform topography measurements using interferometry, reflectometry, profilometry, triangulated laser, wavefront phase imagining, capacitive sensing, etc.

Metrology device 100 further includes at least one computing system 160 that is communicatively coupled to the detector 150 to receive measurement data acquired by the detector 150, as well as metrology instrument 170 to acquire topography measurements. The computing system 160 is further configured to control and monitor operation of the metrology device 100, including the light source 110, polarizing elements 104, 112, optical element 105, chuck 108, stage 109, etc. For example, the computing system 160 may be configured to control the relative position and orientation of the sample 101 with respect to the optical head 115, e.g., including positioning desired measurement locations on sample 101 with respect to the optical head 115 and to control tip, tilt, azimuth angle, or any combination thereof. The computing system 160 may be further configured to determine one or more parameters of a sample based on measurement data, e.g., the spectral signal received from detector 150, as well as orientations of one or more of the polarizing elements 104, 112, optical element 105, etc. The computing system 160 may be configured to receive and/or acquire metrology data from the detector 150 and to control and acquire information from one or more subsystems of the metrology device 100, e.g., the detector 150, as well as light source 110, the polarizing elements 104, 112, optical element 105, chuck 108 and stage 109, etc., by a transmission medium that may include wireline and/or wireless portions. The transmission medium, thus, may serve as a data link between the computing system 160 and other subsystems of the metrology device 100.

The at least one computing system 160, for example, may be a workstation, a personal computer, central processing unit or other adequate computer system, or multiple systems. It should be understood that the at least one computing system 160 may be a single computer system or multiple separate or linked computer systems, including one or more processors which may be coupled to one or more computational nodes (blades), which may be interchangeably referred to herein as computing system 160, at least one computing system 160, one or more computing systems 160, etc. In some implementations, the computing system 160 or components of the computing system 160 may be separate from the metrology device 100 while in some implementations, the computing system 160 may be included in or is connected to or otherwise associated with metrology device 100. Additionally, different subsystems of the metrology device 100 may each include a computing system that is configured for carrying out steps associated with the associated subsystem. For example, the at least one computing system 160 may be coupled to a separate computing system that is associated with the detector 150.

The computing system 160 includes at least one processor 162 with memory 164, as well as a user interface (UI) 168, which are communicatively coupled via a bus 161. The memory 164 or other non-transitory computer-usable storage medium, includes computer-readable program code 166 embodied thereof and may be used by the computing system 160 for causing the at least one computing system 160 to control the metrology device 100 and/or to perform functions including compensating for deformation for the sample during measurement, as described herein. The data structures and software code for automatically implementing one or more acts described in this detailed description can be implemented by one of ordinary skill in the art in light of the present disclosure and stored, e.g., on a computer-usable storage medium, e.g., memory 164, which may be any device or medium that can store code and/or data for use by a computer system, such as the computing system 160. The computer-usable storage medium may be, but is not limited to, include read-only memory, a random access memory, magnetic and optical storage devices such as disk drives, magnetic tape, etc. Additionally, the functions described herein may be embodied in whole or in part within the circuitry of an application specific integrated circuit (ASIC) or a programmable logic device (PLD), and the functions may be embodied in a computer understandable descriptor language which may be used to create an ASIC or PLD that operates as herein described.

The computing system 160 may be configured to determine one or more characteristics of the sample 101 based on metrology data acquired by detector 150, as well as other metrology device 100 configurations, such as orientations of one or more of the polarizing elements 104, 112, and optical element 105, and the relative position and orientation of the sample 101 with respect to the optical head 115, e.g., angle of incidence, azimuth angle, etc. By way of example, the computing system 160 may determine one or more characteristics of the sample 101 using any known metrology techniques, including but not limited to direct measurement, modeling, or machine learning techniques.

For example, the computing system 160 may determine one or more characteristics of the sample 101 using direct measurement. With direct measurement, for example, metrology data is acquired from the sample 101 and the acquired data is used, along with known device parameters, to directly calculate a desired sample characteristic using well known equations.

In another example, the computing system 160 may determine one or more characteristics of the sample 101 using modeling. With modeling, a model of the sample is used that is based on the physical properties of the structure of the sample, such as the materials and the nominal parameters of the structure, e.g., film thicknesses, optical properties of materials, line and space widths, etc., as well as device parameters, such as wavelengths of light, angle of incidence, azimuth angle with respect to structures on the sample, polarization state, etc. The parameters of interest are floating parameters in the model that may be varied and predicted data may be calculated for parameter variations of the model, e.g., using effective medium theory (EMT), finite-difference time-domain (FDTD), transfer matrix method (TMM), the Fourier modal method (FMM)/rigorous coupled-wave analysis (RCWA), the finite element method (FEM), or other similar techniques. The measured data from the sample 101 may be compared to the predicted data for the parameter variations, e.g., in a nonlinear regression process, until a good fit is achieved between the predicted data and the measured data, at which time the fitted parameters are considered an accurate representation of the parameters of the structure under test. The modeling process may be performed in real-time or may be performed using pre-generated modeling data, e.g., stored in a library.

In another example, the computing system 160 may determine one or more characteristics of the sample 101 using machine learning techniques. Machine learning algorithms that may be used for metrology, for example, may include, but are not limited to, linear regression, neural networks, deep learning, convolution neural-network (CNN), ensemble methods, support vector machine (SVM), random forest, etc., or combination of multiple models in sequential mode and/or parallel mode. Machine learning does not use a physical model of the sample, but instead trains a machine learning model using reference data, e.g., measured or synthetic data for one or more reference samples measured by the metrology device 100 which includes variations in the values of parameters of interest.

As discussed herein, the computing system 160 is configured to compensate for local deformations of the sample 101, which may alter the angle of incidence, the azimuth angle, or both, of light 102 with respect to the surface of the sample 101 during measurement. The computing system 160 may compensate for the localized deformations of the sample 101 while using any desired metrology technique, including, but not limited to those discussed above.

Local deformations of the sample 101, for example, may be produced due to deformations due to the sample's deviation from flatness, e.g., bow and warp, and deformations caused by the chuck. For example, the sample 101 may be mounted to the chuck, e.g., clamped by vacuum or electrostatic force or edge clamping, and features of the chuck may be imprinted on the top surface of the sample 101, sometimes referred to as chuck imprinting. Chuck imprinting, for example, may be caused to surface features of the chuck, such as lift pin apertures, vacuum channels, paddle access channels, etc., as well as particles on the chuck. Moreover, with greater deformation of a sample, typically a larger clamping force is used, which results in more pronounced chuck imprinting. Additionally, chucks with less than full contact with the sample may cause edge deformation of the sample 101, e.g., referred to as edge flapping. Additionally, other types of clamping, such as edge clamping, may produce local deformations on the sample 101. Further, if the sample 101 is mounted to the chuck by gravity, e.g., without clamping force, the chuck may still cause deformations of the sample 101, such as edge flapping or chuck imprinting of surface features, such as particles, or when the sample 101 is held on lift pins during measurement. The computing system 160 may compensate for local deformations of the sample 101 using a map of localized deformations of the sample. The computing system 160, for example, may be configured to obtain a map of localized deformations of the sample by generating the map, e.g., using measurements performed by metrology instrument 170, or by fetching the map, e.g., stored in memory 164 or other data storage, where the map may be previously generated, e.g., by the same or different metrology device. The computing system 160 may be configured to use the map of localized deformations of the sample to correct for alterations of the angle of incidence, the azimuth angle, or both, of light 102 with respect to the surface of the sample 101 caused by a local deformation of the sample 101 at the location of measurement.

For example, the computing system 160 may determine values for the angle of incidence, the azimuth angle, or both with respect to the measurement location on the sample based on the localized deformation of the sample at that location and the nominal values for the angle of incidence, the azimuth angle, or both. The accuracy of the values determined for the angle of incidence, the azimuth angle, or both may be adequate for the optical system of the metrology device 100 and/or the type of metrology being performed. In one implementation, for example if the values determined for angle of incidence, the azimuth angle, or both is considered accurate, the computing system 160 may be configured to adjust the relative position and orientation of the sample 101 with respect to the optical head 115, e.g., by adjusting tip, tilt, azimuth angle, or any combination thereof, to compensate for the local deformation. In some implementations, the relative position and orientation of the sample 101 with respect to the optical head 115 may be adjusted to compensate for the local deformation, even if the values determined for angle of incidence, the azimuth angle, or both are not considered sufficiently accurate, e.g., to reduce the impact of the local deformation. In another example, if the values determined for angle of incidence, the azimuth angle, or both is considered accurate, the computing system 160 may adjust the device parameters used for modeling (or other metrology technique) from their nominal values to their determined values.

In another implementation, for example, the computing system 160 may be configured to correct for alterations caused by local deformation of the sample 101 by parameterizing the angle of incidence and azimuth angle at the measurement location based on the map of localized deformations of the sample, which is used along with the measured data from the measurement location to determine one or characteristics of the sample. For example, the angle of incidence and azimuth angle may be parameterized based on the expected angle of incidence and the expected azimuth angle, e.g., the values for the angle of incidence and azimuth angle at the measurement location as determined from the map of localized deformations of the sample. If the values determined for angle of incidence, the azimuth angle, or both are not considered sufficiently accurate, i.e., the values are an approximation, the expected angle of incidence and expected azimuth angle at the measurement location may be floating parameters in the model, which are varied along with other variable parameters, e.g., sample parameters, until a good fit is achieved to determine the one or more characteristics of the sample.

In some implementations, a combination of techniques may be used to correct for alterations caused by local deformation of the sample 101 based on the map of localized deformations. For example, if the values determined for angle of incidence, the azimuth angle, or both are not considered sufficiently accurate for the optical system and/or type of metrology being performed, i.e., the values are an approximation, the relative position and orientation of the sample 101 with respect to the optical head 115 may be adjusted based on the approximate values to at least partially compensate for the local deformation, and the angle of incidence and azimuth angle may be floating parameters in the model, which are varied along with other variable parameters, e.g., sample parameters, until a good fit is achieved to determine the one or more characteristics of the sample.

The resulting measurements of the sample 101, e.g., the one or more determined characteristics of the sample 101, produced while compensating for local deformation of the sample 101, may be reported and fed forward or fed back to the process equipment to adjust the appropriate fabrication steps to compensate for any detected variances in the fabrication process. The computing system 160, for example, may include a communication port 169 that may be any type of communication connection, such as to the internet or any other computer network. The communication port 169 may be used to receive instructions that are used to program the computing system 160 to perform any one or more of the functions described herein and/or to export signals, e.g., with measurement results and/or instructions, to another system, such as external process tools, in a feed forward or feedback process in order to adjust a process parameter associated with a fabrication process step of the samples based on the measurement results.

Semiconductor wafers and substrates, and other similar devices, may suffer from a deviation from flatness, such as bow, warp, twist, etc. due to various factors such as stress during manufacturing processes, temperature gradients, or material properties, and which may result in various simple or complex shapes of the wafers, such as bowl shape, dome shape, saddle shape, etc. Bow, for example, may be considered a deviation of the center point of the median surface of a free, un-clamped sample from a reference plane. Warp, for example, may be considered as the difference between maximum and minimum distances of the median surface of a free, un-clamped sample from the reference plane. Other measures of bow and warp may be used, such as the height of the sample with respect to a plane of the metrology device or the change in height over a defined distance, including the diameter of the sample. The deviation from flatness for the sample may be based on the bow and wafer measurements as well as other measurements if desired. Whether a sample has a significant deviation from flatness may depend on the metrology system, e.g., the optical design of the metrology device or the sensitivity of the metrology technique being employed, or the amount of force that is required to clamp the sample to the surface of the chuck using vacuum or electrostatic force.

Samples that experience high levels of a deviation from flatness, e.g., bow or warp, may be resistant to being clamped down on a chuck and may require a high vacuum in a vacuum chuck to be fully clamped down. Such samples, however, may experience a significant deformation even after they are fully clamped down to a chuck, e.g., with sample overhang flipping up or down depending on type of deformation. Additionally, mounting a sample on a chuck may produce an imprint of chuck features, e.g., edge ring, lift pins, vacuum rings, particles, etc., that produce local deformations on the top surface of the sample. Chuck imprinting is exacerbated when a high vacuum is used to mount the sample to the chuck.

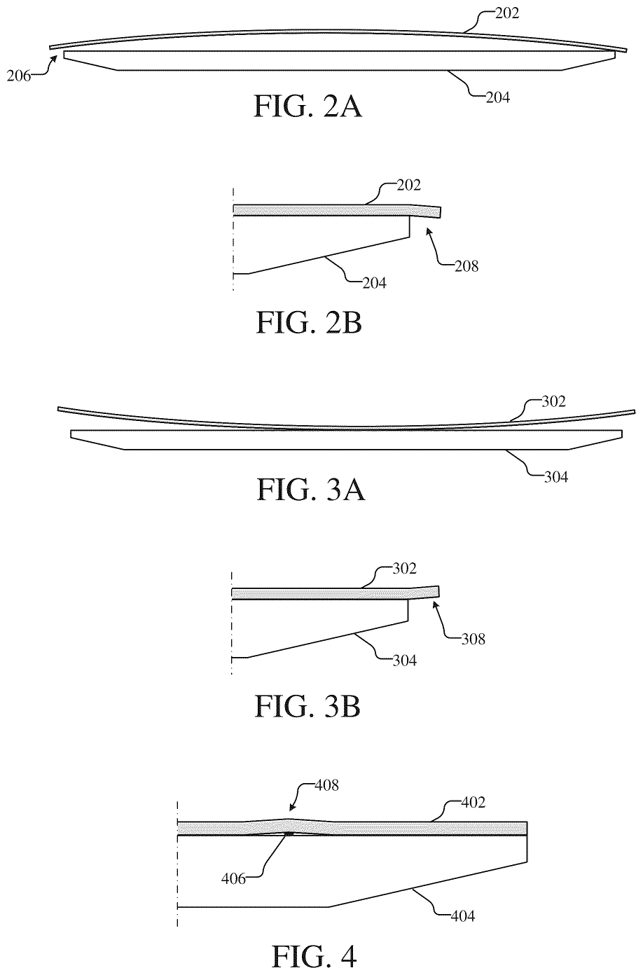

FIG. 2A, by way of example, illustrates a side view of a sample 202 and a chuck 204 with less than full contact with the sample before the sample 202 is clamped down to the surface of the chuck 204. Sample 202 is illustrated with a high deviation from flatness, e.g., bow having a dome shape. In FIG. 2A, sample 202 is generally dome shaped but sample 202 also includes warp, as illustrated by the gap 206 between the edge of the sample 202 and the chuck 204, making vacuum clamping to the chuck 204 difficult. Once clamped to the surface of the chuck 204, portions of the sample 202 may remain deformed.

FIG. 2B, by way of example, illustrates a portion of the sample 202 and the chuck 204 after the sample 202 is clamped down to the surface of the chuck 204. As illustrated, the outside portion 208 of the sample 202, e.g., overhanging the chuck 204, may remain deformed.

FIGS. 3A and 3B, are similar to FIGS. 2A and 2B, and illustrate a side view of a sample 302 and a chuck 304 with less than full contact with the sample before and after the sample 302 is clamped to the surface of the chuck 304. FIG. 3A illustrates the sample 302 with a high deviation from flatness, e.g., bow having a bowl or dish shape, which makes vacuum clamping to the chuck 204 difficult. FIG. 3B illustrates a portion of the sample 302 and the chuck 304 after the sample 302 is clamped down to the surface of the chuck 304 and illustrates an outside portion 308 of the sample 302, e.g., overhanging the chuck 304, may remain deformed.

The edge deformation of samples may affect the accuracy of measurements performed by the metrology device 100, illustrated in FIG. 1, or other similar metrology devices, that are sensitive to changes in the angle of incidence or azimuth angle of the radiation with respect to the surface of the sample. For example, a flat sample, i.e., a sample without a significant deviation from flatness, may exhibit edge deformation of approximately 100 mrad (5 mdeg). For bowed wafers, the edge deformation may be greater than 1800 mrad (>100 mdeg). Edge deformation, for example, may be particularly problematic at positions on the sample that extends past the edge of the chuck. For example, with a chuck that has a radius of 135 mm, and a 300 mm wafers, approximately 20% of a wafer may suffer from edge deformation that affects measurement.

FIG. 4 illustrates a portion of a sample 402 and a chuck 404 with full contact with the sample after the sample 402 is mounted to the surface of the chuck 404, e.g., either by gravity or by additional clamping force, such as by vacuum or electrostatic force. The sample 402, by way of example, may be flat, e.g., no significant deviation from flatness, but an object 406 on the surface of the chuck 404 may cause imprinting 408 on the top surface of the sample 402. The object 406, for example, may be a particle or may be a feature of the chuck, 404, such as a lift pin aperture or vacuum channel.

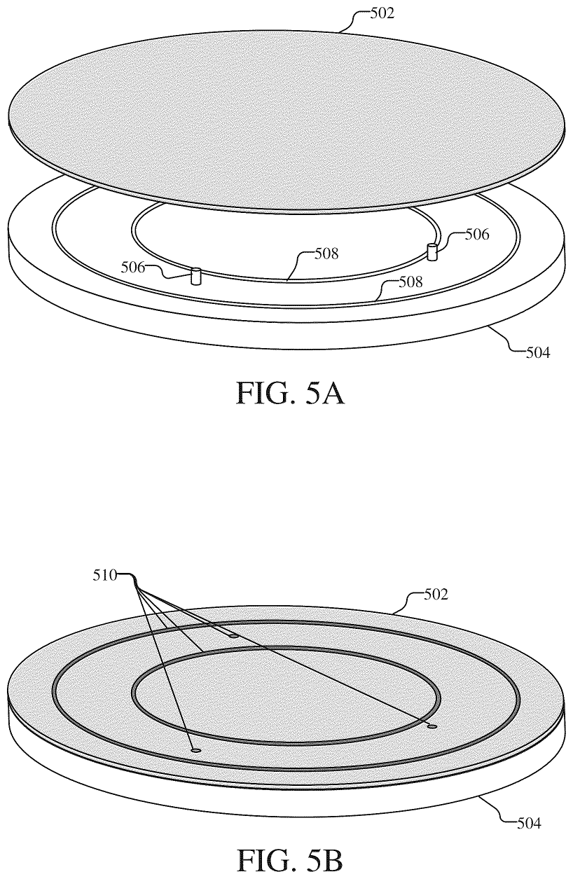

FIG. 5A, by way of example, is a perspective view of a sample 502 and a full contact vacuum chuck 504. In FIG. 5A, the sample 502 is unmounted and may be in the process of being lowered onto the lift pins 506 of the chuck 504. The sample 502 is illustrated in FIG. 5A without significant deformation. As can be seen, the chuck 504 includes a number of surface features, including lift pins 506 and vacuum channels 508.

FIG. 5B is a perspective view of a sample 502 mounted to the chuck 504, e.g., vacuum clamped to the surface of the chuck 504, e.g., after being lowered onto the surface of the chuck by the lift pins 506. As illustrated in FIG. 5B, chuck imprinting from the surface features of the chuck 504 may cause localized surface deformations 510 on the top surface of the sample 502 when the sample 502 is mounted to the chuck 504. The severity of the localized surface deformations 510 may be related to the strength of the clamping force used to mount the sample 502 on the chuck 504, but localized surface deformations 510 may be present with little vacuum or even no vacuum. For example, if the sample 502 is mounted on chuck 504 by gravity, i.e., no additional clamping force is used, the sample deformation (e.g., bow or warp) of the sample 502 may result in a localized surface deformation at some locations.

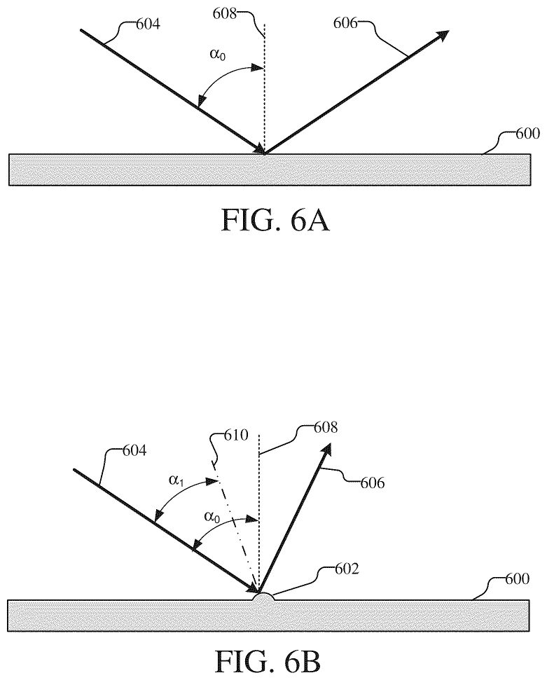

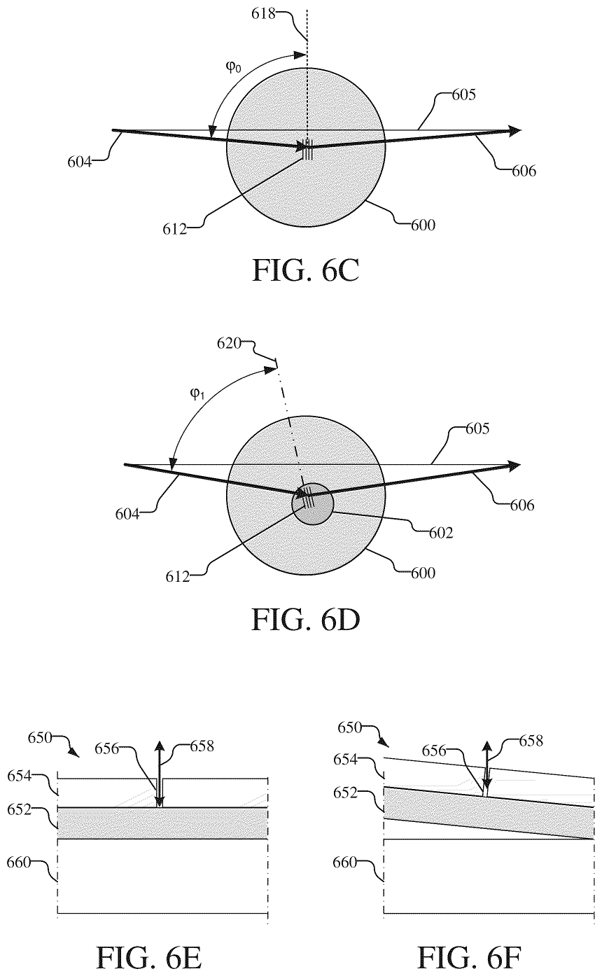

FIGS. 6A and 6B, by way of example, illustrate a side view of a sample 600 and the effect of a localized deformation on the angle of incidence of light during measurement. FIG. 6A illustrates the sample 600 without a localized deformation and illustrates incident light 604 and reflected light 606. The incident light 604 is incident at the measurement location with an angle of incidence of do with respect to the nominal normal vector 608, i.e., the normal vector for a planar surface of the sample 600. The sample 600 does not have a localized deformation and, accordingly, the normal vector at the measurement location is coincident with the nominal normal vector 608. In contrast, FIG. 6B illustrates the sample 600 with a localized deformation 602 and illustrates that the normal vector 610 at the measurement location is not coincident with the nominal normal vector 608. Accordingly, as illustrated, the localized deformation 602 causes the incident light 604 to have a different angle of incidence α₁ with respect to the normal vector 610 at the measurement location then the angle of incidence α₀ with respect to the nominal normal vector 608 of the sample 600. It should be understood that the variation in the angle of incidence due to the localized deformation is greatly exaggerated in FIG. 6B, but many metrology techniques are sensitive to the angle of incidence parameter and, accordingly, even a small variation in the angle of incidence may have an undesirable impact on the accuracy of the measurement.

FIGS. 6C and 6D, by way of example, illustrate a top view of the sample 600 and the effect of a localized deformation on the azimuth angle of the light during measurement. FIG. 6C illustrates the sample 600 without a localized deformation and illustrates incident light 604 and reflected light 606 forming a plane of incidence 605 and further illustrates a pattern 612 on the sample 600. The plane of incidence 605 may be orthogonal to the planar surface of the sample 600 and the incident light 604 and the plane of incidence 605 have an azimuth angle of φ₀ with respect to the measurement location, e.g., as defined by a reference vector 618 parallel to the pattern 612 at the measurement location. In contrast, FIG. 6D illustrates the sample 600 with the localized deformation 602. The plane of incidence 605 is orthogonal to the tangent plane at the measurement location, but due to the localized deformation 602 the plane of incidence 605 may not be orthogonal to the planar surface of the sample 600. The localized deformation 602 and/or the alteration of the plane of incidence 605 may alter the azimuth angle φ₁ of the incident light 604 and the plane of incidence 605 with respect to the measurement location, e.g., as defined by a reference vector 620 parallel to the pattern 612 at the measurement location. It should be understood that the variation in the azimuth angle due to the localized deformation is greatly exaggerated in FIG. 6D, but many metrology techniques are sensitive to the azimuth angle and, accordingly, even a small variation in the azimuth angle may have an undesirable impact on the accuracy of the measurement.

FIGS. 6E and 6F, by way of example, illustrate a side view of a portion of a sample 650 and the effect of a localized deformation on normal incidence illumination. FIGS. 6E and 6F illustrate the sample 650 mounted on a chuck 660. The sample 650 is illustrated as including a substrate 652 and a layer 654 with a feature 656 that may be a high aspect ratio feature, and normally incident light 658 that is incident on the feature 656. FIG. 6E illustrates the sample 650 without a localized deformation and illustrates the incident light 658 reaching the bottom of the feature 656. In contrast, FIG. 6F illustrates the sample 600 with a localized deformation, e.g., caused by a sample deformation or chuck imprinting, resulting in the incident light 658 not being normally incident at the measurement location. As illustrated in FIG. 6F as a result of the localized deformation, less or none of the incident light 658 may reach the bottom of the feature 656, which will adversely impact the measurement of the feature.

Metrology systems, such as metrology device 100, illustrated in FIG. 1, are typically highly sensitive to device parameters, such as angle of incidence and azimuth angle. Localized deformation of samples, such as those illustrated in FIGS. 2B, 3B, 4, and 5B, may alter device parameters, such as angle of incidence and azimuth angle. Accordingly, locations in which localized deformations are present may suffer from inaccurate and unreliable measurements and are conventionally excluded from measurement. As noted above, for example, with less than full contact chucks, localized deformation may affect a relatively large percentage of the sample, e.g., approximately 20% or more of a wafer, and thus, a large percentage of a sample being excluded from measurement due to localized deformations.

To compensate for localized deformation of a sample during measurement, a map of localized deformations of the sample may be generated and used to correct for alterations of the angle of incidence, or azimuth angle, or both, during measurement at a measurement location. The map of localized deformations resulting from the sample's deviation from flatness may be generated by a measurement of the sample deformation before the sample is mounted to a chuck. For example, the shape and degree of the sample deformation may be measured using topography measurements, e.g., using interferometry, reflectometry, profilometry, triangulated laser, wavefront phase imagining, capacitive sensing, etc. Based on the measured sample deformation, the localized deformation of the sample after the sample is mounted, e.g., by gravity or clamping, to the chuck may be calculated, e.g., based on known parameters, such as thickness, materials, initial stress values, or may be empirically determined using reference samples and stored in a library. In some implementations, the shape and degree of the sample deformation may be measured, e.g., using topography measurements, after the sample has been mounted to the chuck. In some implementations, the map of localized deformations resulting from chuck imprinting may be generated by measuring the shape and degree of the sample deformation, e.g., using topography measurements, after the sample has been mounted to the chuck. In some implementations, the map of localized deformations resulting from chuck imprinting may be generated based on a reference sample that is mounted to the chuck, and measuring the shape and degree of deformation of the reference sample due to chuck imprinting.

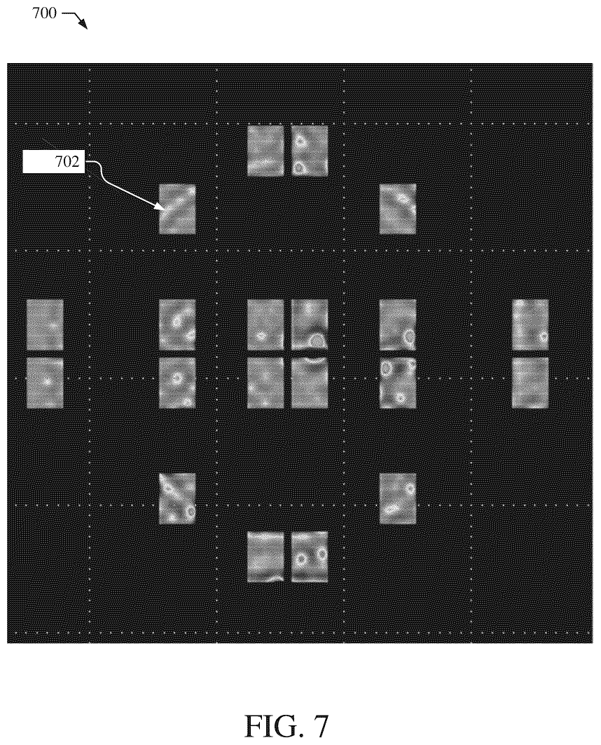

FIG. 7 illustrates an example of a map of localized deformations 700 of a sample resulting from chuck imprinting on a sample. As illustrated in FIG. 7, the map of localized deformations of a sample may be a map of localized deformations within one or more separate regions of interest on the sample. In some implementations, the map of localized deformations may be over the entire sample. The map of localized deformations 700, for example, was produced using topography measurements using the Unifire 7900 from Onto Innovation Inc.

The map of localized deformations 700 includes deformations 702 produced from surface features from the chuck, such as vacuum channels.

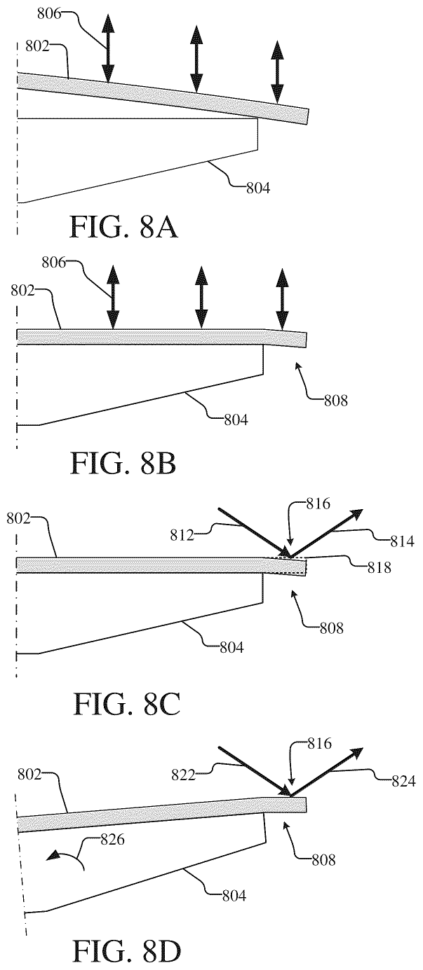

FIG. 8A shows a side view of a portion of a sample 802 and chuck 804 and illustrates one implementation of generating a map of localized deformations of the sample. In FIG. 8A, the sample 802 is un-clamped so that the sample deformation due to the sample's deviation from flatness is exhibited. The shape and degree of the deformation across the sample 802 is measured using topography measurements, illustrated by arrows 806 at multiple locations. Once the shape and degree of sample deformation, e.g., bow and warp, are measured, the way the sample will deform when mounted to the chuck 804 may be predicted to produce a map of the localized deformations of the sample. For example, the localized deformations of the sample 802 may be calculated based on the measured shape and degree of the deformation at various locations on the sample 802 as well as known characteristics of the chuck, such as diameter of the chuck.

FIG. 8B shows another side view of a portion of the sample 802 and the chuck 804 and illustrates another implementation of generating a map of localized deformations of the sample. In FIG. 8B, the sample 802 is clamped to the chuck, so that the sample is relatively flat but still exhibits deformation due to the sample's deviation from flatness, e.g., shown as edge roll-off 808. Similar to FIG. 8A, the shape and degree of the deformation across the sample 802 is measured using topography measurements, illustrated by arrows 806 at multiple locations. The map of localized deformations of the sample 802 is produced based on the measured topography measurements, i.e., surface height measurements, at multiple locations of the sample 802.

Once the map of localized deformations of the sample has been generated, alterations of the angle of incidence, azimuth angle, or both, produced at a particular location during measurement may be corrected based on the shape and degree of deformation at that location determined from the map of localized deformations.

FIG. 8C shows a side view of a portion of the sample 802 and the chuck 804 and illustrates one implementation of compensating for alterations of the angle of incidence, azimuth angle, or both based on the map of localized deformations of the sample. In FIG. 8C, the sample 802 is clamped to the chuck 804 during measurement, e.g., by the metrology device 100 shown in FIG. 1. Similar to FIG. 8B, the sample 802 in FIG. 8C exhibits a localized deformation, e.g., may include an alteration of a surface height, normal incidence, or both, due to the sample's deviation from flatness, e.g., shown as edge roll-off 808. As illustrated by the incident beam 812 and the reflected beam 814, the sample 802 is measured at a location 816 that is at the edge roll-off 808, and thus, the angle of incidence, azimuth angle, or both of the incident beam 812 and the reflected beam 814 is affected by the local deformation. During the determination of one or more characteristics of the sample 802 at the measurement location 816, the map of localized deformations of the sample may be used to compensate for the alteration of the angle of incidence, azimuth angle, or both of the incident beam 812 and the reflected beam 814, as illustrated by the dotted outline 818 of sample 802 with the local deformation, e.g., edge roll-off 808, corrected. For example, the sample 802 and device parameters may be modeled to determine the one or more characteristics of the sample 802. The angle of incidence and azimuth angle of the incident beam 812 and the reflected beam 814 may be parameterized based on the expected angle of incidence and azimuth angle at the measurement location as determined from the map of localized deformations of the sample. The parameterized angle of incidence and azimuth angle may be included in the model as a fixed parameter or floating parameter that is varied around the expected angle of incidence and azimuth angle at the measurement location. The measured data from the location 816 may be compared to calculated data produced by the model for each parameter variation, e.g., in a nonlinear regression process, until a good fit is achieved. Once a good fit is achieved, the values of the variable sample parameters are determined to be an accurate representation of the one or more characteristics of interest of the sample 802 at location 816, with an accurate representation of the angle of incidence and azimuth angle of the incident beam 812 and the reflected beam 814.

FIG. 8D shows a side view of a portion of the sample 802 and the chuck 804 and illustrates one implementation of compensating for alterations of the angle of incidence, azimuth angle, or both based on the map of localized deformations of the sample. Similar to FIG. 8C, in FIG. 8D the sample 802 is clamped to the chuck 804 during measurement and exhibits a localized deformation, e.g., an alteration of a surface height, normal incidence, or both, shown as edge roll-off 808, due to the sample's deviation from flatness. During the measurement of the sample 802 at location 816, e.g., as illustrated by incident beam 822 and the reflected beam 824, the orientation of the sample 802 with respect to the optical head is adjusted based on the map of localized deformations of the sample to compensate for the alteration of the angle of incidence, azimuth angle, or both of the incident beam 822 and the reflected beam 824 that would otherwise occur. For example, as illustrated by arrow 826, the sample 802 may be tipped or tilted relative to the head of the metrology device to compensate for the local deformation at location 816, e.g., by adjusting at least one of tip and tilt and azimuth angle of the stage (not shown) and chuck 804. In another example, the head of metrology device may be tipped or tilted relative to the sample 802 to compensate for the local deformation at location 816. By compensating for the local deformation at location 816, the angle of incidence, azimuth angle, or both of the incident beam 822 and the reflected beam 824 are unaffected by the local deformation and the resulting measurement at location 816 is accurate.

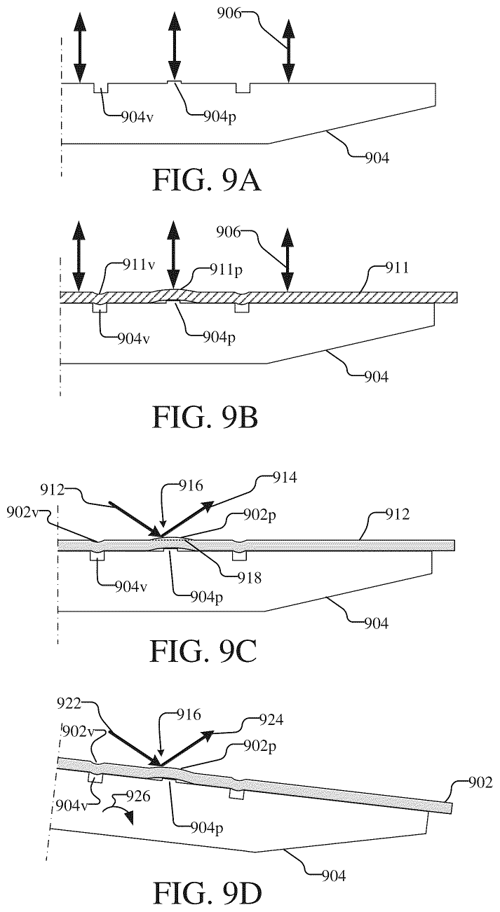

FIG. 9A shows a side view of a portion of a chuck 904 and illustrates one implementation of generating a map of localized deformations of a sample. In FIG. 9A, no sample is present, but the surface features of the chuck 904, such as recessed vacuum channels 904v and raised particles 904p, are measured, e.g., using topography measurements, illustrated by arrows 906 at multiple locations. Once the surface features of the chuck 904 are measured, the way a sample will deform, e.g., the height and total area of deformation caused by chuck imprinting, when mounted to the chuck 904 may be predicted to produce a map of the localized deformations of the sample. For example, the map of localized deformations of the sample may be determined based on the measured topography of the chuck 904 and the known, or expected, characteristic parameters of the sample to be measured, from which the expected shape and degree of deformations at various locations on the sample once clamped to the chuck 904 may be calculated.

FIG. 9B shows a side view of a portion of a reference sample 911 and the chuck 904 and illustrates another implementation of generating a map of localized deformations of the sample. The reference sample 911 may be a sample that is flat or that has a known topography. The reference sample 911 may be similar to the sample that is to be measured, e.g., the reference sample 911 may be produced from the same lot as the sample to be measured, or in some implementations, the reference sample 911 may be the sample that is to be measured. In other implementations, the reference sample 911 may be dissimilar to the sample to be tested, but may provide an accurate representation of the shape and degree of deformations that will be produced on the sample to be tested at various locations due to chuck imprinting from the surface features 904v, 904p from the chuck 904. As illustrated, the reference sample 911 is clamped to the chuck 904 so that the surface features 904v, 904p from the chuck 904 are imprinted on the surface of the reference sample 911 as deformations 911v and 911p. The shape and degree of the deformations 911v, 911p across the reference sample 911 is measured using topography measurements, illustrated by arrows 906 at multiple locations. The map of localized deformations of the sample is produced based on the measured topography measurements, i.e., surface height measurements, at multiple locations of the reference sample 911.

Once the map of localized deformations of the sample due to chuck imprinting has been generated, alterations of the angle of incidence, azimuth angle, or both, produced by chuck imprinting at a particular location during measurement may be corrected based on the shape and degree of deformation at that location determined from the map of localized deformations.

FIG. 9C shows a side view of a portion of the sample 902 under test and the chuck 904 and illustrates one implementation of compensating for alterations of the angle of incidence, azimuth angle, or both based on the map of localized deformations of the sample. In FIG. 9C, the sample 902 is clamped to the chuck 904 during measurement, e.g., by the metrology device 100 shown in FIG. 1. Similar to FIG. 9B, the sample 902 in FIG. 9C exhibits localized deformations 902v and 902p, e.g., alterations of a surface height, normal incidence, or both, due to chuck imprinting of the respective surface features 904v and 904p of the chuck 904. As illustrated by the incident beam 912 and the reflected beam 914, the sample 902 is measured at a location 916 that is a location with deformation 902p, and thus, the angle of incidence, azimuth angle, or both of the incident beam 912 and the reflected beam 914 is affected by the local deformation. During the determination of one or more characteristics of the sample 902 at the measurement location 916, the map of localized deformations of the sample may be used to compensate for the alteration of the angle of incidence, azimuth angle, or both of the incident beam 912 and the reflected beam 914, as illustrated by the dotted outline 918 of sample 902 with the localized deformation 902p corrected. For example, the sample 902 and device parameters may be modeled to determine the one or more characteristics of the sample 902. The angle of incidence and azimuth angle of the incident beam 912 and the reflected beam 914 may be parameterized based on the expected angle of incidence and azimuth angle at the measurement location as determined from the map of localized deformations of the sample. The parameterized angle of incidence and azimuth angle may be included in the model as a fixed parameter or floating parameter that is varied around the expected angle of incidence and azimuth angle at the measurement location. The measured data from the location 916 may be compared to calculated data produced by the model for each parameter variation, e.g., in a nonlinear regression process, until a good fit is achieved. Once a good fit is achieved, the values of the variable sample parameters are determined to be an accurate representation of the one or more characteristics of interest of the sample 902 at location 916, with an accurate representation of the angle of incidence and azimuth angle of the incident beam 912 and the reflected beam 914.

FIG. 9D shows a side view of a portion of the sample 902 and the chuck 904 and illustrates one implementation of compensating for alterations of the angle of incidence, azimuth angle, or both based on the map of localized deformations of the sample. Similar to FIG. 9C, in FIG. 9D the sample 902 is clamped to the chuck 904 during measurement and exhibits localized deformations 902v and 902p, e.g., alterations of a surface height, normal incidence, or both, due to chuck imprinting of the respective surface features 904v and 904p of the chuck 904. During the measurement of the sample 902 at location 916, e.g., as illustrated by incident beam 922 and the reflected beam 924, the orientation of the sample 902 with respect to the optical head is adjusted based on the map of localized deformations of the sample to compensate for the alteration of the angle of incidence, azimuth angle, or both of the incident beam 922 and the reflected beam 924 that would otherwise occur. For example, as illustrated by arrow 926, the sample 902 may be tipped or tilted relative to the head of the metrology device to compensate for the local deformation at location 916, e.g., by adjusting at least one of tip and tilt and azimuth angle of the stage (not shown) and chuck 904. In another example, the head of metrology device may be tipped or tilted relative to the sample 902 to compensate for the local deformation at location 916. By compensating for the local deformation at location 916, the angle of incidence, azimuth angle, or both of the incident beam 922 and the reflected beam 924 are unaffected by the local deformation and the resulting measurement at location 916 is accurate.

In some implementations, the measurements performed in FIG. 8A or FIG. 8B may be combined with the measurements performed in FIG. 9A or FIG. 9B to produce a map of localized deformations of the sample produced by both the sample deformation, i.e., deviation from flatness, and chuck imprinting from surface features of the chuck. Once the map of localized deformations of the sample due to sample deformation and chuck imprinting has been generated, alterations of the angle of incidence, azimuth angle, or both, produced by sample deformation and chuck imprinting at a particular location during measurement may be corrected based on the shape and degree of deformation at that location determined from the map of localized deformations.

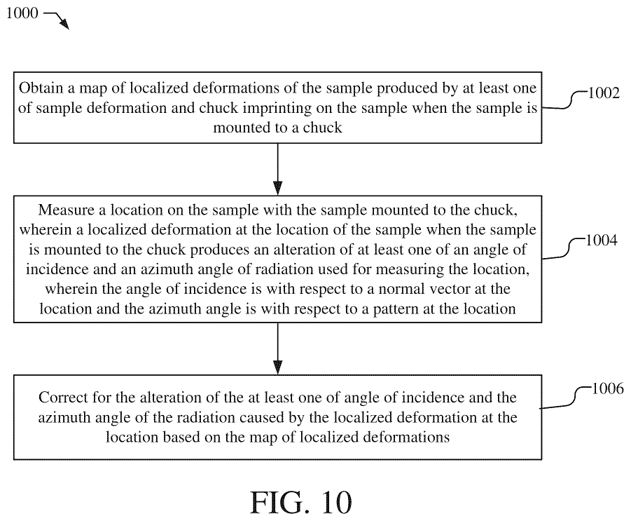

FIG. 10 shows an illustrative flowchart depicting an example method 1000 for compensating for deformation of a sample during measurement of the sample, according to some implementations. In some implementations, the example method 1000 may be performed by a metrology device including one or more processors, e.g., such as metrology device 100 and computing system 160 shown in FIG. 1. The metrology may be, for example, optical metrology that uses light, but is not necessarily so limited unless specifically stated. For example, in some implementations, the metrology may be X-ray or any other desired types of non-contact metrology, e.g., in which radiation is used.

As illustrated in FIG. 10, the method includes obtaining a map of localized deformations of the sample produced by at least one of sample deformation and chuck imprinting on the sample when the sample is mounted to a chuck (1002), e.g., as illustrated in FIGS. 8A, 8B, 9A, and 9B. The map of localized deformations, for example, is obtained based on one or more measurements, e.g., of sample deformation, surface features of the chuck or both. The map of localized deformations may be stored in memory, e.g., memory 164 in FIG. 1, and may be obtained from memory by the metrology device while measuring a location of the sample. In one implementation, the map of localized deformations of the sample may be obtained by measuring a shape and a degree of the sample deformation without applying a clamping force to the sample, e.g., as illustrated in FIGS. 8A and 8B. In one implementation, the map of localized deformations of the sample may be obtained by measuring a shape and a degree of deformations produced at a plurality of locations on samples by chuck imprinting when samples are mounted to the chuck, e.g., as illustrated in FIGS. 9A and 9B. In one implementation, the map of localized deformations of the sample may be obtained by obtaining a shape and a degree of the sample deformation without applying a clamping force to the sample, e.g., as illustrated in FIGS. 8A and 8B, and obtaining a shape and a degree of deformations produced at a plurality of locations on samples by chuck imprinting when samples are mounted to the chuck, e.g., as illustrated in FIGS. 9A and 9B. The shape and the degree of the sample deformation and the shape and the degree of deformations produced at a plurality of locations on samples by chuck imprinting may be combined to generate the map of the localized deformations of the sample. In one implementation, the map of localized deformations of the sample may be obtained by measuring a surface height of the sample at a plurality of locations to determine the localized deformations of the sample, e.g., as illustrated in FIGS. 8B and 9B. A means for obtaining a map of localized deformations of the sample produced by at least one of sample deformation and chuck imprinting on the sample when the sample is mounted to a chuck may be, e.g., metrology device 100 shown in FIG. 1 and the at least one memory 164 and at least one processor 162 in the computing system 160 shown in FIG. 1.

The method may further include measuring a location on the sample with the sample mounted to the chuck, where a localized deformation at the location of the sample when the sample is mounted to the chuck produces an alteration of at least one of an angle of incidence and an azimuth angle of radiation used for measuring the location, where the angle of incidence is with respect to a normal vector at the location and the azimuth angle is with respect to a pattern at the location (1004), e.g., as illustrated in FIGS. 8C, 8D, 9C, and 9D. A means for measuring a location on the sample with the sample mounted to the chuck, where a localized deformation at the location of the sample when the sample is mounted to the chuck produces an alteration of at least one of an angle of incidence and an azimuth angle of radiation used for measuring the location, where the angle of incidence is with respect to a normal vector at the location and the azimuth angle is with respect to a pattern at the location may be, e.g., metrology device 100 shown in FIG. 1 and the at least one memory 164 and at least one processor 162 in the computing system 160 shown in FIG. 1.

The method may further include correcting for the alteration of the at least one of angle of incidence and the azimuth angle of the radiation caused by the localized deformation at the location based on the map of localized deformations (1006), e.g., as illustrated in FIGS. 8C, 8D, 9C, and 9D. The localized deformation of the sample, for example, may include an alteration of at least one of a surface height and normal incidence at the location on the sample, e.g., as illustrated in FIGS. 8C, 8D, 9C, and 9D. In one implementation, correcting for the alteration of the at least one of angle of incidence and the azimuth angle of the radiation caused by the localized deformation at the location based on the map of localized deformations may include adjusting at least one of tip and tilt and azimuth angle of the sample during measurement of the location on the sample to compensate for the localized deformation at the location on the sample, e.g., as illustrated in FIGS. 8D and 9D. In one implementation, correcting for the alteration of the at least one of angle of incidence and the azimuth angle of the radiation caused by the localized deformation at the location based on the map of localized deformations may include adjusting at least one of tip and tilt and azimuth angle of an optical head of an optical metrology device during measurement of the location on the sample to compensate for the localized deformation at the location on the sample, e.g., as discussed in reference to FIGS. 8D and 9D. In one implementation, correcting for the alteration of the at least one of angle of incidence and the azimuth angle of the radiation caused by the localized deformation at the location based on the map of localized deformations may include using the localized deformation at the location on the sample to adjust at least one of an angle of incidence parameter and an azimuth angle parameter for modeling the sample during measurement of the location on the sample, e.g., as illustrated in FIGS. 8C and 9C. In one example, the at least one of the angle of incidence parameter and the azimuth angle parameter for modeling the sample may be adjusted by replacing nominal values of the at least one of the angle of incidence parameter and the azimuth angle parameter with expected values of the at least one of the angle of incidence parameter and the azimuth angle parameter based on the map of localized deformations. In one example, the at least one of the angle of incidence parameter and the azimuth angle parameter for modeling the sample may be adjusted by floating the at least one of the angle of incidence parameter and the azimuth angle parameter for modeling based on expected values of the at least one of the angle of incidence parameter and the azimuth angle parameter determined from the map of localized deformations. A means for correcting for the alteration of the at least one of angle of incidence and the azimuth angle of the radiation caused by the localized deformation at the location based on the map of localized deformations may be, e.g., metrology device 100 shown in FIG. 1 and the at least one memory 164 and at least one processor 162 in the computing system 160 shown in FIG. 1.

The above description is intended to be illustrative, and not restrictive. For example, the above-described examples (or one or more aspects thereof) may be used in combination with each other. Other implementations can be used, such as by one of ordinary skill in the art upon reviewing the above description. Also, various features may be grouped together and less than all features of a particular disclosed implementation may be used. Thus, the following aspects are hereby incorporated into the above description as examples or implementations, with each aspect standing on its own as a separate implementation, and it is contemplated that such implementations can be combined with each other in various combinations or permutations. Therefore, the spirit and scope of the appended claims should not be limited to the foregoing description.

What is claimed is:

1. A method of compensating for deformation of a sample during measurement, comprising:
obtaining a map of localized deformations of the sample produced by at least one of sample deformation and chuck imprinting on the sample when the sample is mounted to a chuck;
measuring a location on the sample with the sample mounted to the chuck, wherein a localized deformation at the location of the sample when the sample is mounted to the chuck produces an alteration of at least one of an angle of incidence and an azimuth angle of radiation used for measuring the location, wherein the angle of incidence is with respect to a normal vector at the location and the azimuth angle is with respect to a pattern at the location; and
correcting for the alteration of the at least one of angle of incidence and the azimuth angle of the radiation caused by the localized deformation at the location based on the map of localized deformations.

2. The method of claim 1, wherein obtaining the map of localized deformations of the sample comprises measuring a shape and a degree of the sample deformation without applying a clamping force to the sample.

3. The method of claim 1, wherein obtaining the map of localized deformations of the sample comprises measuring a shape and a degree of deformations produced at a plurality of locations on samples by chuck imprinting when samples are mounted to the chuck.

4. The method of claim 1, wherein obtaining the map of localized deformations of the sample comprises:
obtaining a shape and a degree of the sample deformation without applying a clamping force to the sample;
obtaining a shape and a degree of deformations produced at a plurality of locations on samples by chuck imprinting when samples are mounted to the chuck; and
combining the shape and the degree of the sample deformation and the shape and the degree of deformations produced at a plurality of locations on samples by chuck imprinting to generate the map of the localized deformations of the sample.

5. The method of claim 1, wherein obtaining the map of localized deformations of the sample comprises measuring a surface height of the sample at a plurality of locations to determine the localized deformations of the sample.

6. The method of claim 1, wherein correcting for the alteration of the at least one of angle of incidence and the azimuth angle of the radiation caused by the localized deformation at the location based on the map of localized deformations comprises adjusting at least one of tip and tilt and azimuth angle of the sample during measurement of the location on the sample to compensate for the localized deformation at the location on the sample.

7. The method of claim 1, wherein correcting for the alteration of the at least one of angle of incidence and the azimuth angle of the radiation caused by the localized deformation at the location based on the map of localized deformations comprises adjusting at least one of tip and tilt and azimuth angle of a head of a metrology device during measurement of the location on the sample to compensate for the localized deformation at the location on the sample.

8. The method of claim 1, wherein correcting for the alteration of the at least one of angle of incidence and the azimuth angle of the radiation caused by the localized deformation at the location based on the map of localized deformations comprises using the localized deformation at the location on the sample to adjust at least one of an angle of incidence parameter and an azimuth angle parameter for modeling the sample during measurement of the location on the sample.

9. The method of claim 1, wherein the localized deformation of the sample comprises an alteration of at least one of a surface height and normal incidence at the location on the sample.

10. A metrology device configured for compensating for deformation of a sample during measurement, comprising:
a stage and chuck configured to mount a sample;
at least one metrology head configured for measuring a location on the sample with the sample mounted to the chuck; and
at least one processor coupled to the stage and chuck and the at least one metrology head, the at least one processor configured to:
obtain a map of localized deformations of the sample produced by at least one of sample deformation and chuck imprinting on the sample when the sample is mounted to a chuck;
measure the location on the sample with the sample mounted to the chuck, wherein a localized deformation at the location of the sample when the sample is mounted to the chuck produces an alteration of at least one of an angle of incidence and an azimuth angle of radiation used for measuring the location, wherein the angle of incidence is with respect to a normal vector at the location and the azimuth angle is with respect to a pattern at the location; and
correct for the alteration of the at least one of angle of incidence and the azimuth angle of the radiation caused by the localized deformation at the location based on the map of localized deformations.

11. The metrology device of claim 10, wherein the at least one processor is configured to obtain the map of localized deformations of the sample by being configured to measure a shape and a degree of the sample deformation without applying a clamping force to the sample.

12. The metrology device of claim 10, wherein the at least one processor is configured to obtain the map of localized deformations of the sample by being configured to measure a shape and a degree of deformations produced at a plurality of locations on samples by chuck imprinting when samples are mounted to the chuck.

13. The metrology device of claim 10, wherein the at least one processor is configured to obtain the map of localized deformations of the sample by being configured to:
obtain a shape and a degree of the sample deformation without applying a clamping force to the sample;
obtain a shape and a degree of deformations produced at a plurality of locations on samples by chuck imprinting when samples are mounted to the chuck; and
combine the shape and the degree of the sample deformation and the shape and the degree of deformations produced at a plurality of locations on samples by chuck imprinting to generate the map of the localized deformations of the sample.

14. The metrology device of claim 10, wherein the at least one processor is configured to obtain the map of localized deformations of the sample by being configured to measure a surface height of the sample at a plurality of locations with the at least one metrology head to determine the localized deformations of the sample.

15. The metrology device of claim 10, wherein the at least one processor is configured to correct for the alteration of the at least one of angle of incidence and the azimuth angle of the radiation caused by the localized deformation at the location based on the map of localized deformations by being configured to adjust at least one of tip and tilt and azimuth angle of the sample during measurement of the location on the sample to compensate for the localized deformation at the location on the sample.

16. The metrology device of claim 10, wherein the at least one processor is configured to correct for the alteration of the at least one of angle of incidence and the azimuth angle of the radiation caused by the localized deformation at the location based on the map of localized deformations by being configured to adjust at least one of tip and tilt and azimuth angle of the at least one metrology head during measurement of the location on the sample to compensate for the localized deformation at the location on the sample.

17. The metrology device of claim 10, wherein the at least one processor is configured to correct for the alteration of the at least one of angle of incidence and the azimuth angle of the radiation caused by the localized deformation at the location based on the map of localized deformations by being configured to use the localized deformation at the location on the sample to adjust at least one of an angle of incidence parameter and an azimuth angle parameter for modeling the sample during measurement of the location on the sample.

18. The metrology device of claim 10, wherein the localized deformation of the sample comprises an alteration of at least one of a surface height and normal incidence at the location on the sample.

19. A metrology device configured for compensating for deformation of a sample during measurement, comprising:
means for obtaining a map of localized deformations of the sample produced by at least one of sample deformation and chuck imprinting on the sample when the sample is mounted to a chuck;
means for measuring a location on the sample with the sample mounted to the chuck, wherein a localized deformation at the location of the sample when the sample is mounted to the chuck produces an alteration of at least one of an angle of incidence and an azimuth angle of radiation used for measuring the location, wherein the angle of incidence is with respect to a normal vector at the location and the azimuth angle is with respect to a pattern at the location; and
means for correcting for the alteration of the at least one of angle of incidence and the azimuth angle of the radiation caused by the localized deformation at the location based on the map of localized deformations.
